(19) United States
(12) Patent Application Publication
(10) Pub. No.: US 2002/0133709 A1
(43) Pub. Date: Sep. 19, 2002

(54) Optical data transfer system - ODTS; Optically based anti-virus protection system - OBAPS

(76) Inventor: Terry George Hoffman, Belleair, FL (US)

Correspondence Address: TERRY GEORGE HOFFMAN, 2706 FOXFIRE COURT, CLEARWATER, FL, 33761, US

(21) Appl. No.: 09/804,796

(22) Filed: Mar. 14, 2001

(51) Int. Cl. H04L 9/32; G06F 11/30

(52) U.S. Cl. 713/188

(57) ABSTRACT

By a sequencing of programmed information, coupled with optical scanners, separated by a ‘Void’ or ‘Gap’, there is no possibility for a rogue virus to infiltrate the recipient's system.

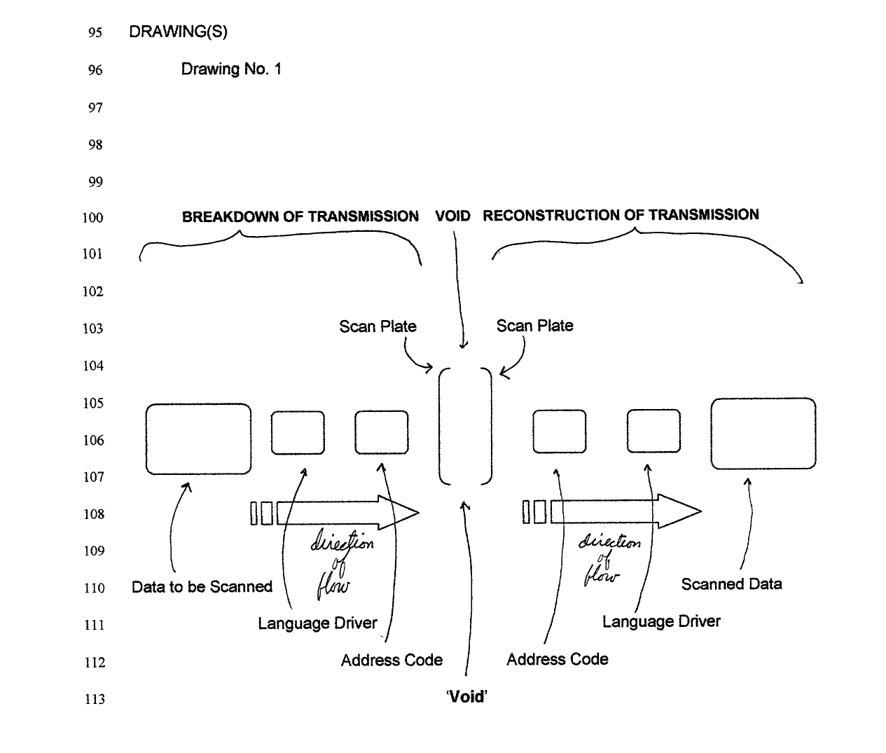

Additionally, by the inclusion in the base process of specially designated patterns of receipt of data, a basic level of security is automatically built in. This security can be enhanced by developing levels of identification encryption, which are proprietary to the recipient's system.

### CROSS REFERENCE TO RELATED APPLICATIONS

1. Computer Anti-Virus Protection System

2. Optically Based Secure Data Transfer System

### STATEMENT REGARDING FEDERALLY SPONSORED RESEARCH OR DEVELOPMENT

None; Not Applicable

### REFERENCE TO A MICROWAVE APPENDIX

None; Not Applicable

### BACKGROUND OF INVENTION

The system has its basis in the concept of soundless messaging developed between ocean going vessels during the First World War and enhanced by encryption during the Second World War. Messaging was accomplished by light signals between ships.

There is one primary distinguishing difference between traditional ‘anti-virus’ methodologies and the concept being presented herein. With existing programs and technological support, Viruses ride on the information transferred, either as riders to the information itself or as riders to the program identification command process. A physical break in the flow of either the ‘driver’ program or the transfer of ‘hard’ data, would prevent a parasite from being able to jump from the source to the recipient.

### BRIEF SUMMARY OF THE INVENTION

ODTS/OBAPS is a system, comprised of both software and hardware components. It is designed to permit the subscriber to 1: protect the relay of information from being compromised or polluted by rouge viruses and, 2: electronically encrypt the data, so as to maintain the confidential integrity of the information being relayed.

It is based on fiber optics as the physical medium for transfer of data. It utilizes existing server and scanner technology, coupled with a regimen of commands, in software vocabulary, to transfer the data ‘bubble’ to the correct destination point. It proposes to utilize existing methodology to translate data from electronic bubbles of information to decipherable text or diagrammatic representations.

The specific characteristic of light pattern signalization, coupled with the ‘Void”, is that the recipient scanner can accept the light based code, without importing the rouge virus attached, or ‘riding’ within the transmission. This characteristic of light coding is not achievable with conventional forms of sound based transmissions.

By creating a physical ‘void’ and precoding command drivers and address points, the system, presented herein, optically scans and imports data, in designated ‘fields.’ Since the fields of data need to be customized, by user, based on the user's data needs, the proprietary utilization (pre-coded coordinates) of the fields themselves have the ability to become a form of encryption. Thus, the data has the characteristic of not being accessible to outside sources, which are external to the system. Nor can external sources have access to encrypted coding to determine the active scan fields. Additionally, there can be a random rotation of passwords to determine entry into the system. The sender does not have to know the pathway of choice, on any given day, to the final fields of data import.

To recap, the primary value is two-fold. Firstly, by creating a ‘dam’ rather than a ‘bridge’, the virus is contained or isolated from the recipient. Secondly, by having user specific addresses and fields of data scans, there exists inherently, in the concept ‘system,’ a modified form of encryption, which can be easily code-scrambled, creating further levels or degrees of security.

### BRIEF DESCRIPTION OF THE SEVERAL VIEWS OF THE DRAWING

Attached is a Process Flow Chart, illustrating the Concept Design. The diagram represents the conceptual Flow Process and the linkages and sequential manner by which the hardware and software interrelate.

### DETAILED DESCRIPTION OF THE INVENTION

The Invention is a system comprised of hardware and software that, by inclusion of a ‘void’ or ‘gap’, protects the transmission of data from acting as a vehicle of bridge for the import of a rogue virus.

The device is ‘in-line’ with the movement of data. It assumes that the data is moved by fiber optic cable, in light patterns or ‘electronic information bubbles’.

In large systems, the device can be either at the NAP distribution point that precedes the final transmittal address or can be internal to the installation point. This creates a redundancy of equipment for the user, but assures complete protection from any tapped intruder.

In small systems (LAN or individual PC) the device is positioned at the local point to receipt, prior to the PC or router.

Traditional data transfer is a two element process. Element 1 is the address routing. Element 2 is the actual data transmission with the ‘language’ driver: .doc, .xis, .pp, etc.

The revised sequence proposed requires four elements. Element 1 is the address routing. Element 2 is the ‘Driver Code Identification. Element 3 is the ‘Scan Pattern Code.’ Element 4 is the actual data to be scanned.

Both sides of the Void work the same way, but in reverse reading. The drawing attached indicates the five sequence relationship of elements.

1: The physical ‘void’ in the data transmission process does NOT allow the virus to ride on the transmission. (Note: the Void exists, even is the two graphic scanner are physically contacting. The Virus cannot ‘leap’ the Void.

2: Via the integration of linkages and the coded sequencing (integrated hardware and software), a basic level of self encrypted security is created that can be further scrambled and encrypted, without compromising speed of transmission or capacity.
